(19) United States
(12) Patent Application Publication
(10) Pub. No.: US 2003/0220800 A1
(43) Pub. Date: Nov. 27, 2003

(54) Coding multichannel audio signals

(76) Inventor: Dmitry N. Budnikov, N. Novgorod (RU)

Correspondence Address: Timothy N. Trop, TROP, PRUNER & HU, P.C., STE 100, 8554 KATY FWY, HOUSTON, TX, 77024-1841, US

(21) Appl. No.: 10/152,205

(22) Filed: May 21, 2002

(51) Int. Cl. G10L 19/00

(52) U.S. Cl. 704/500

(57) ABSTRACT

Data in a first channel of an audio signal may be compared to data in a second channel of the audio signal. Based on the comparison, the coding of the audio signal is adjusted to take into account any differences between the data distribution across the first and second channels. In one embodiment, an audio device determines the number of bits available to code the audio signal and adaptively redistributes the available bits between the first and second channels based on the comparison before coding the audio signal.

### BACKGROUND

This invention relates generally to coding audio signals, and more particularly to coding multichannel audio signals.

Audio coding involves producing a digital representation of an audio input. Often, an audio signal (analog or digital) is coded as a digital signal, using a minimum amount of digital information commonly referred to as bitrate. When decoded or reproduced, the encoded or compressed digital representation may produce a signal that is substantially the same as the original audio signal. Several audio processing systems combine this encoding and decoding functionality in one unit generally known in the art as an audio encoder/decoder (codec).

An audio codec compliant with any one of many available standards may sample the audio signal. Each sample may be quantized, creating an audio sample word. Each audio sample word may then be formatted to form a subframe, which is multiplexed with other subframes to form a digital audio stream. Sometimes an audio signal may include two channels, which may be either a stereo pair or two independent feeds. In the context of a stereo audio signal, two subframes make up a signal frame, including one sample from each of the two channels.

An encoder is typically used to code the audio signal for the audio encoder located within most of the conventional audio codecs. While coding a stereo audio signal, one or more coding parameters may be specified for the encoder. For example, one of the coding parameters is the number of bits available for processing the spectral and scaling coefficients in a current audio signal frame.

To provide an efficient coding of the stereo audio signal at a given bitrate, adjustment of the coding parameters may be desired during audio coding. However, such an adjustment may be difficult because while the available number of bits is primarily determined by the bitrate set out for a channel in the stereo audio signal, redistribution of the available number of bits may have to be known beforehand for the quantization of each channel in an encoder. Accordingly, a fixed channel-to-channel bit ratio is typically provided. This approach may be adequate with techniques that usually produce a less informative right channel compared to the left channel, such as Intensity Stereo and Mid/Side Stereo techniques.

On the other hand, in audio processing systems in which informative content (e.g., data in one channel) is continuously varying against the content in another channel of a multichannel audio signal, a fixed bit redistribution approach may not be sufficient to effectively code the multichannel audio signal. As an example, when a stereo audio signal or a multichannel audio signal with two or more channels is being conventionally coded, the number of available bits is equally divided among the channels regardless of a current state of the audio signal. That is, if one of the two channels at a certain moment of time is silent or contains a narrowband or a low intensity signal, then coding of that channel with fixed or preallocated number of available bits may be redundant because these signal segments are relatively less informative. As a result, the overall quality of the coded multichannel audio signal is significantly compromised, wasting a substantial portion of bandwidth available for the coding purposes.

Thus, there is a continuing need for better ways to code multichannel audio signals.

### BRIEF DESCRIPTION OF THE DRAWINGS

FIG. 1 is a schematic depiction of an audio device in which an audio coder module codes an audio signal consistent with one embodiment of the present invention;

FIG. 2 is a flow chart showing the audio coder module of FIG. 1 for adaptively coding an audio signal in a first and a second channel according to one embodiment of the present invention;

FIG. 3 is a flow chart showing a bit redistributing coder for coding a stereo audio signal in a left and a right channel by adaptively redistributing available bits during coding in accordance with one embodiment of the present invention;

FIG. 4 is a flow chart showing the audio coder module of FIG. 1 that provides an adaptive stereo pair coding with bit redistribution in accordance with one embodiment of the present invention; and

FIG. 5 is a schematic depiction of a processor-based system that incorporates the audio coder module of FIG. 1 according to one embodiment of the present invention.

### DETAILED DESCRIPTION

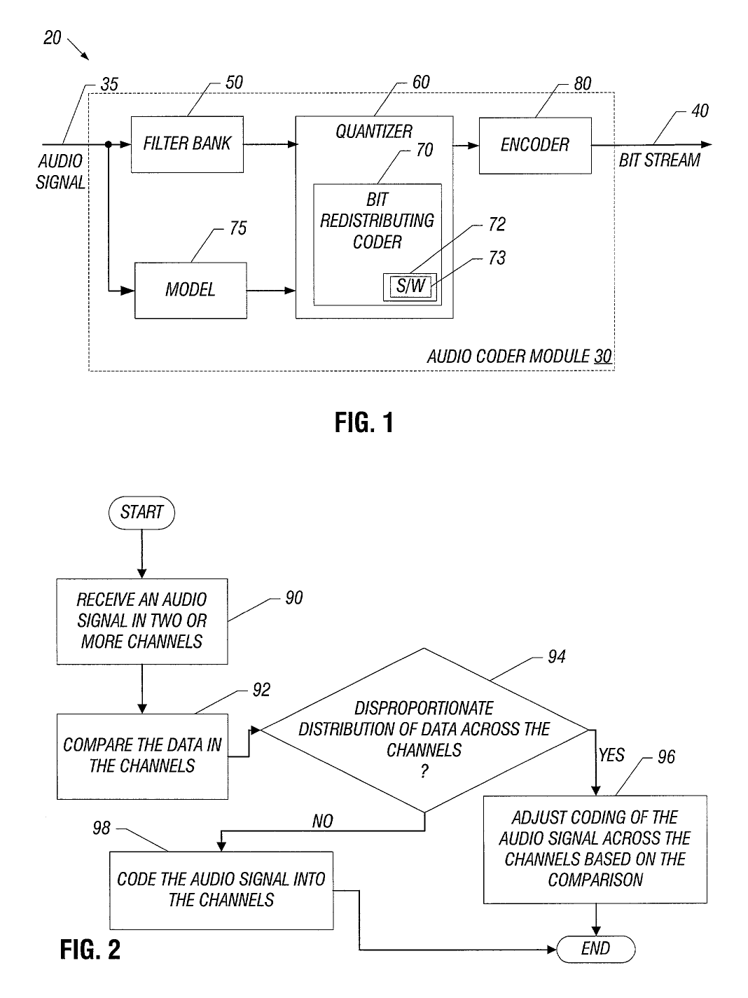

An audio device 20 is shown in FIG. 1 in which an audio coder module 30 receives for coding an audio signal over an input port 35 according to one embodiment of the present invention. Upon coding, a coded audio signal may be provided in a bit stream over an output port 40. In one embodiment, an audio signal may include a stereo audio signal of a multichannel format, incorporating data in a left and a right channel. The stereo audio signal may comprise one or more stereo signal frames. Each stereo signal may include two subframes. Each subframe may incorporate one sample from each of the left and right channels. By making use of specific properties of the multichannel signals, the audio coder module 30 provides an adaptive coding of the stereo audio signal in some embodiments of the present invention.

In one embodiment, the audio device 20 may be used for encoding of multichannel audio signals, such as a multichannel audio signal format set forth by Dolby Laboratories, Inc. of San Francisco, Calif. Practically, using the audio coder module 30, any one of many audio codecs based on available formats and/or standards may appropriately encode a multichannel audio signal as a set of pairs including but not limited to “front left—front right” and “rear left—rear right.” Alternatively, in some other embodiments, encoding of a multichannel audio signal may be provided with simultaneous encoding of more than two channels.

Essentially, one or more coding parameters may be specified and selectively adjusted during coding of a stereo audio signal. For example, one of the coding parameters is the number of bits available for processing the spectral and scaling coefficients in a current audio signal frame. An efficient coding may be provided at a given bitrate by adaptively adjusting the number of bits available among the left and right channels of the stereo audio signal according to one embodiment of the present invention.

In one embodiment, the audio coder module 30 comprises a filter bank 50 to decompose the audio signal received over the input port 35 into signal components. A quantizer 60 is operably coupled to the filter bank 50 for further quantizing these signal components. A bit redistributing coder 70 may be provided at the quantizer 60 to code the audio signal based on an adaptive coding process consistent with one embodiment of the present invention. Consistent with one embodiment of the present invention, the bit redistributing coder 70 may incorporate a storage device 72, storing associated bit redistributing coder software 73 that provides the adaptive coding process.

The audio coder module 30 may further comprise a model 75 for specifying the adaptive coding process. In the illustrated embodiment, the model 75 mimics a human auditory system of a human observer, employing masking phenomena. Accordingly, the model 75 masks certain sounds or error contribution using a masking threshold based on a human observer's auditory system. Of course, any perceptual model capable of being adapted to provide a relatively high quality coding of the audio signal may be used in other embodiments of the present invention.

The audio coder module 30 further includes an encoder 80 to receive from the quantizer 60 quantized and coded samples with corresponding bit allocation information to be used for the left and right channels during the adaptive coding process. Using these samples and bit allocation information, the encoder 80 may generate the bit stream at the output port 40, outputting the coded audio signal. In this way, the coded audio signal may comprise digitized audio that is coded relatively more effectively than the conventionally coded audio signal, i.e., with no adaptation. As an example, the coded audio signal may be a pulse code modulated (PCM) data stream carrying digitized audio.

In operation, the filter bank 50 changes the representation of an audio signal from the time domain to the frequency domain. The quantizer 60 then may quantize the resulting frequency-domain coefficients before the encoder 80 encodes the quantized frequency-domain coefficients. Based on the model 75, a bit allocation may be determined for each individual frequency-domain coefficient associated with each of the channels of the audio signal. Finally, the frequency-domain coefficients are quantized to the necessary precision and formatted into the audio bit stream over the output port 40.

More specifically, a time-to-frequency mapping is used in the filter bank 50 to decompose the audio signal into subsampled spectral components in one embodiment of the present invention. Depending on a type of the filter bank 50 deployed, however, the subsampled spectral components may be either subband samples or frequency lines. The output of the filter bank 50, which may be a result of a parallel transform, in one embodiment, may be used to estimate a masking threshold based on the model 75, incorporating rules known from psychoacoustics. Thereafter, the quantizer 60 quantizes the subband samples or frequency lines, which then are coded by the bit distributing coder 70.

In one embodiment, the coding is carried out in a manner such that the noise, which may be introduced while quantizing, is ideally kept below the masked threshold. The encoder 80 then assembles the bit stream including samples of the audio signal being mapped, quantized, and coded. In one case, conventional frame packing is used to assemble the bit stream at the port 40. Other suitable bit stream forming techniques may be deployed in some embodiments of the present invention.

Consistent with one embodiment of the present invention, the audio coder module 30 may receive an audio signal over the input port 35 (FIG. 1) in two or more channels at block 90, as shown in FIG. 2. The audio coder module 30 then compares data in the channels of the audio signal at block 92. To determine whether the data is proportionately distributed across the channels of the audio signal, a check at diamond 94 provides an indication as to any disproportionate distribution of data. Based on this indication, one or more coding parameters may be automatically adjusted for the audio signal in some embodiments at block 96, instead of coding without taking in account a change in the distribution of data between the first and second channels. Conversely, if the check at diamond 94 determines a proportionate distribution of data across the channels, the audio signal may be coded according a default coding scheme, i.e., based on the initially specified coding parameters at block 98. In one case, the default coding scheme entails equally dividing the number of bits available between the channels while coding the audio signal.

However, to adjust a particular coding parameter of the audio signal (e.g., the number of bits available to code), the characteristics of the coding parameter may first be determined. In one case, a bitrate for each of the first and second channels of the audio signal may be detected in order to determine the number of bits available to code. Thereafter, the available bits may be redistributed among the first and second channels depending upon a comparison result, indicating which channel is carrying more data relative to the other channel. If no adjustment is desired to the coding parameter of the audio signal, the available bits may be equally divided into the first and second channels based on the default coding scheme.

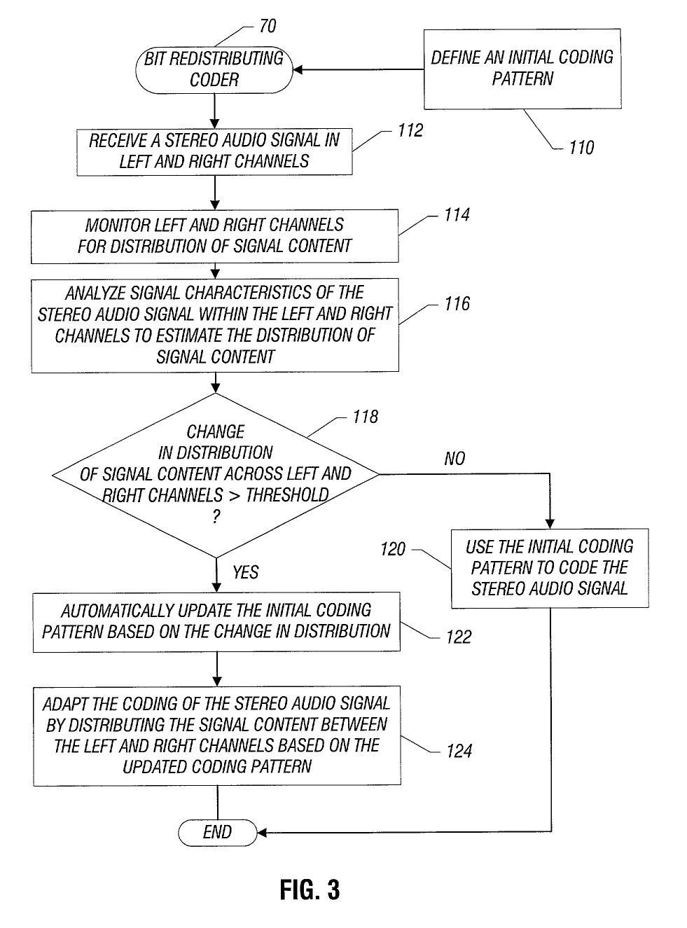

Referring to FIG. 3, an initial coding pattern (e.g. one or more coding parameters) may be defined for the bit distributing coder 70 at block 110 in one embodiment of the present invention. Of course, as discussed above, a default coding scheme or pattern may be used for such purpose in some embodiments. At block 112, a stereo audio signal that is appropriately quantized by the quantizer 60 (FIG. 1) may be received at the bit distributing coder 70 in a left and a right channel for the coding purposes. Distribution of signal content, i.e., the data present within the left and right channels may be monitored at block 114. One signal segment of the left channel may be compared with another signal segment of the right channel to assess a more informative channel over a less informative channel between the left and right channels of the stereo audio signal. In this way, prior to undertaking the coding of the stereo audio signal, signal characteristics of the stereo audio signal may be analyzed within the left and right channels to estimate the distribution of the signal content at block 116.

A check at diamond 118 determines a change in the distribution of signal content across the left and right channels against a threshold indicative of a signal pattern according to one embodiment. The signal pattern may be representative of a normal signal strength, intensity or any one of the desired audio signal characteristics in some embodiments of the present invention. If no significant change is identified in the signal pattern, a default coding of the stereo audio signal may be performed, using the initial coding pattern at block 120. Otherwise, if a change against the threshold is detected at diamond 118, the initial coding pattern may be automatically updated based on such change at block 122. Thus, the coding pattern may be adapted at block 124 by redistributing the signal content into a different number of bits allocated for each of the left and right channels based on the adapted coding pattern. In accordance with one embodiment, at least one more bit of the number of bits available in the bit stream may be allocated to the more informative channel. For example, in a sixteen-bit coder, ten bits may be provided to left channel and the remaining six bits to the right channel, in an event that the left channel is carrying relatively more data than the right channel.

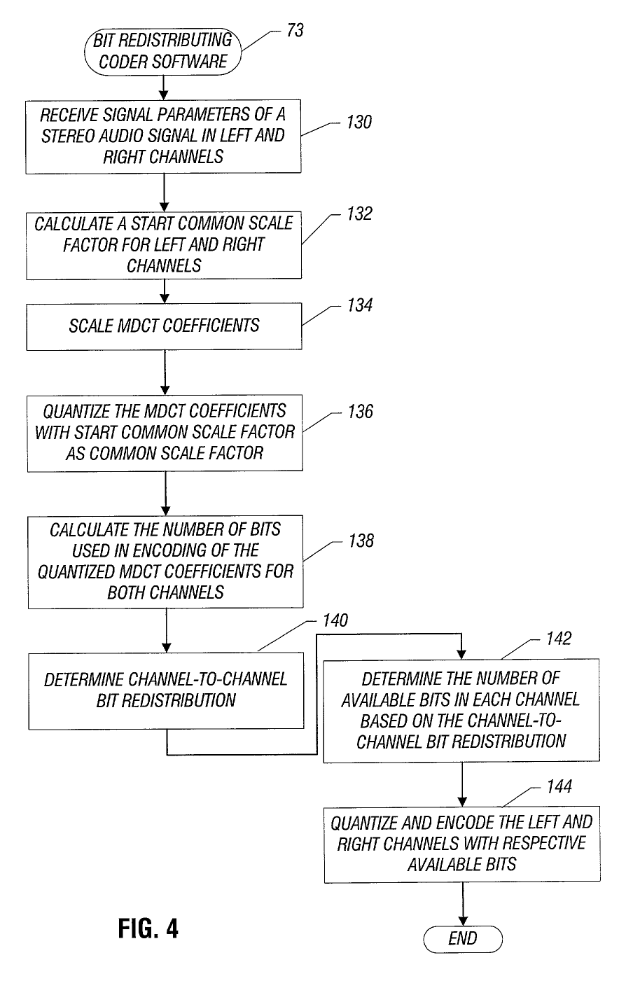

Using the bit redistributing coder software 73 shown in FIG. 4, the audio coder module 30 provides an adaptive stereo pair coding with bit redistribution in one embodiment of the present invention. In the illustrated embodiment, the bit redistributing coder 70 is deployed to code a multichannel audio signal. At block 130, the audio coder module 30 may receive a stereo audio signal in a left and a right channel. For both the channels, at block 132, a start common scale factor may be calculated to scale the modified discrete cosine transform (MDCT) coefficients at block 134. The scaled MDCT coefficients may further be quantized based on the start common scale factors being used as a common scale factor at block 136.

The number of bits used in encoding of the quantized MDCT coefficients may be calculated for both the channels at block 138. Particularly, the number of bits used in coding of the left and right channels may be identified. Using the number of bits being used in the left and right channels, a channel-to-channel bit redistribution ratio may be calculated at block 140. Based on this ratio, the available number of bits after the redistribution of bits may be determined in each channel at block 142. For further quantizing and encoding of the left and right channels, the corresponding redistributed number of bits that are available for coding may be used while forming the bit stream at the output port 40 (FIG. 1) at block 144.

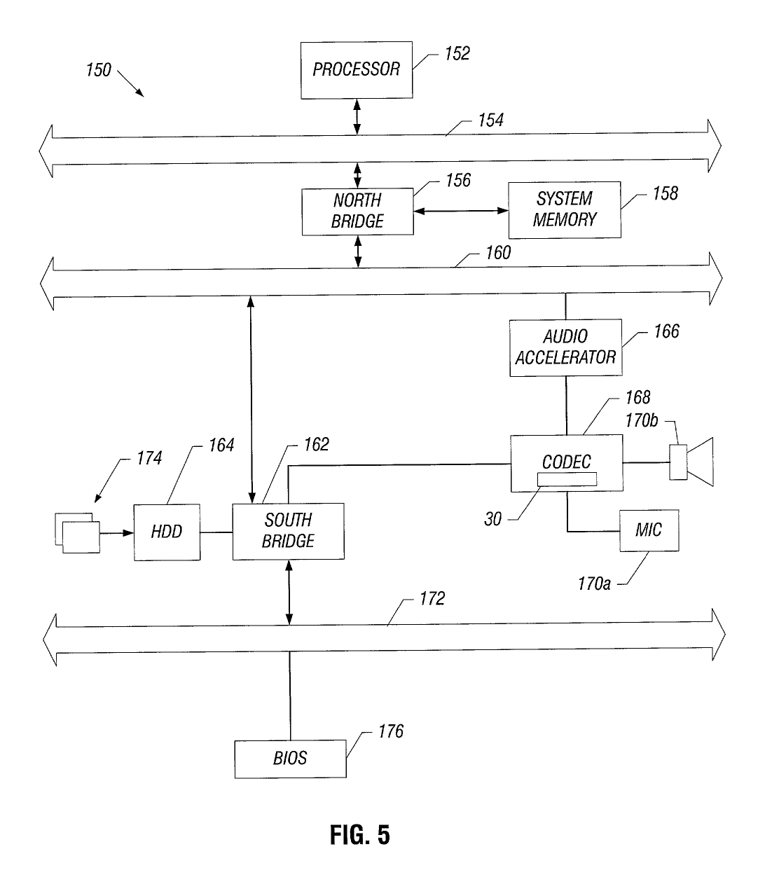

In an illustrated embodiment, the audio coder module 30 is located in a processor-based system 150, shown in FIG. 5, a processor 152 may be coupled to a host bus 154. The host bus 154 is coupled to a north bridge 156, which is further coupled to a system memory 158. The north bridge 156 is also coupled to a bus 160 that in turn is connected to an audio accelerator 166 and a south bridge 162. The south bridge 162 is coupled to a hard disk drive (HDD) 164 that, in one embodiment, may be the source of an audio sound library 174, storing one or more coded audio files processed by the audio coder module 30. Additionally or alternatively, one or more uncoded audio files may be stored in the audio sound library 174. As discussed above, an uncoded audio file may be adaptively coded using the audio coder module 30 as one example.

According to another embodiment, a multichannel audio signal may be fed through a microphone 170b to an audio coder/decoder (codec) 168 where the multichannel audio signal may be coded according to the bit distributing coder 70 shown in FIG. 3. While playing a coded multichannel audio signal, the sounds generated by the processor 152 may be sent through the audio accelerator 166 and the audio codec 168 to a speaker 170b. To appropriately operate the processor-based system 150, the south bridge 162 may be coupled to a basic input/output system (BIOS) memory 176 through an additional bus 172.

In some embodiments, the audio coder module 30 may be located in an audio and video compression standard compliant decoder and encoder, using a motion picture experts group (MPEG) standard. According to one embodiment, the audio codec 168 includes an audio encoder that is useful with a MPEG compliant audio processing library, such as the MPEG-4. A number of audio and video compression standards, including MPEG-1, MPEG-2, and MPEG-4 that are available from the MPEG, for example, ISO/IEC 14496-3 MPEG-4 coding standard: Audio, published 1999 may be used for the audio codec 168. Other audio devices using an audio encoder or the audio codec 168 may be advantageously devised by incorporating the audio coder module 30, achieving significant enhancement in the encoded audio quality in some embodiments of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
comparing data in a first and a second channel of an audio signal; and
adjusting coding of the audio signal based on said comparison.

2. The method of claim 1 including:
determining the number of bits available to code the audio signal; and
redistributing the number or bits between the first and second channels based on said comparison.

3. The method of claim 2 including:
defining a coding pattern for the data in the first and second channels of the audio signal; and
automatically updating said coding pattern based on the comparison.

4. The method of claim 3 including:
receiving a stereo signal frame within the audio signal; and
quantizing the audio signal based on a perceptual model to form a bit stream corresponding to the stereo signal frame.

5. The method of claim 4 including determining from the bit stream the number of bits available to code in the stereo signal frame.

6. The method of claim 5 including:
detecting a bitrate for each of the first and second channels of the audio signal; and
deriving the number of bits available to code from the bitrate.

7. The method of claim 5 including:
comparing one signal segment of the first channel with another signal segment of the second channel to determine a relatively more informative channel over a less informative channel between the first and second channels of the audio signal; and
allocating at least one more bit of the number of bits available in the bit stream corresponding to the stereo signal frame to the more informative channel with respect to the less informative channel while encoding the signal content present into the first and second channels of the audio signal.

8. The method of claim 7, including receiving the audio signal in a multichannel stereo format, wherein the first channel being a left channel of the multichannel stereo format and the second channel being a right channel of the multichannel stereo format.

9. A method comprising:
estimating a signal pattern within at least two channels of a multichannel audio signal based on a distribution of signal content present in the multichannel audio signal across the at least two channels; and
using said signal pattern to redistribute the signal content present into the multichannel audio signal between the at least two channels before encoding the multichannel audio signal.

10. The method of claim 9 including:
monitoring the at least two channels of the multichannel audio signal against a threshold to detect a change in said distribution of the signal content between the at least two channels of the multichannel audio signal; and
determining a redistribution of number of bits available for coding among the at least two channels of the multichannel audio signal based on the change in said distribution of the signal content.

11. A device comprising:
and interface to receive data in a first and second channel of an audio signal; and
an audio device operably coupled to said interface to compare the data in the first and second channels and adjust coding of the audio signal based on said comparison.

12. The device of claim 11, further comprising an audio coding engine to:
determine the number of bits available to code the audio signal; and
redistribute the number of bits between the first and second channels based on said comparison.

13. The device of claim 12, wherein the audio coding engine to:
define a coding pattern for the data in the first and second channels of the audio signal; and
automatically update said coding pattern based on the comparison.

14. The device of claim 13, wherein the audio coding engine to quantize the audio signal based on a perceptual model to form a bit stream corresponding to a stereo signal frame

15. The device of claim 13, wherein the audio coding engine to determine from the bit stream the number of bits available to code in the stereo signal frame.

16. The device of claim 15, wherein the audio coding engine to:
detecting a bitrate for each of the first and second channels of the audio signal; and
deriving the number of bits available to code from the bitrate.

17. The device of claim 16, wherein the audio coding engine to:
compare one signal segment of the first channel with another signal segment of the second channel to determine a relatively more informative channel over a less informative channel between the first and second channels of the audio signal; and
allocate at least one more bit of the number of bits available in the bitstream corresponding to the stereo signal frame to the more informative channel with respect to the less informative channel while encoding the signal content present into the first and second channels of the audio signal.

18. The device of claim 16, wherein the audio coding engine to receive the audio signal in a multichannel stereo format with the first channel being a left channel of the multichannel stereo format and the second channel being a right channel of the multichannel stereo format.

19. A processor-based system comprising:
an audio codec to receive an audio signal including a first and a second channel; and
a storage device operably coupled to said audio codec, said storage device storing a coding engine to compare data in the first and second channels of the audio signal and adjust coding of the audio signal based on said comparison.

20. The processor-based system of claim 19, wherein the coding engine to determine the number of bits available to code the audio signal and redistribute the number or bits between the first and second channels based on said comparison.

21. An article comprising a medium storing instructions that, if executed, enable a processor-based system to perform steps including:
comparing data in a first and second channel of an audio signal; and
adjusting coding of the audio signal based on said comparison.

22. The article of claim 21, comprising a medium storing instruction that, if executed, enable a processor-based system to perform steps including:
determining the number of bits available to code the audio signal; and
redistributing the number or bits between the first and second channels based on said comparison.

23. The article of claim 22, comprising a medium storing instruction that, if executed, enable a processor-based system to perform steps including:
defining a coding pattern for the data in the first and second channels of the audio signal; and
automatically updating said coding pattern based on the comparison.

24. The article of claim 23, comprising a medium storing instructions that, if executed, enable a processor-based system to perform steps including:
receiving a stereo signal frame within the audio signal; and
quantizing the audio signal based on a perceptual model to form a bit stream corresponding to the stereo signal frame.

25. The article of claim 24, comprising a medium storing instructions that, if executed, enable a processor-based system to perform steps including determining from the bit stream the number of bits available to code in the stereo signal frame.

26. The article of claim 25, comprising a medium storing instructions that, if executed, enable a processor-based system to perform steps including:
detecting a bitrate for each of the first and second channels of the audio signal; and
deriving the number of bits available to code from the bitrate.

27. The article of claim 25, comprising a medium storing instructions that, if executed, enable a processor-based system to perform steps including:
comparing one signal segment of the first channel with another signal segment of the second channel to determine a relatively more informative channel over a less informative channel between the first and second channels of the audio signal; and
allocating at least one more bit of the number of bits available in the bit stream corresponding to the stereo signal frame to the more informative channel with respect to the less informative channel while encoding the signal content present into the first and second channels of the audio signal.

28. The article of claim 27, comprising a medium storing instructions that, if executed, enable a processor-based system to perform steps including receiving the audio signal in a multichannel stereo format, wherein the first channel being a left channel of the multichannel stereo format and the second channel being a right channel of the multichannel stereo format.

29. An audio device comprising:
a coder module that estimates a signal pattern within a first and second channel of an audio signal based on a distribution of signal content present into the audio signal across the first and second channels; and
an encoder module that uses said signal pattern from the coder module to redistribute available number of bits while coding the audio signal.

30. The audio device of claim 29, wherein the audio device includes an audio encoder.
